(19) United States
(12) Patent Application Publication
(10) Pub. No.: US 2004/0092656 A1
(43) Pub. Date: May 13, 2004

(54) Multi-component kits and combinations, use thereof and plastic cements obtained therefrom

(76) Inventors: Martin Vogel, Glottertal (DE); Juergen Gruen, Boetzingen (DE); Joachim Schaetzle, Kenzingen (DE); Clemens Schmidt, Denzlingen (DE)

Correspondence Address: Striker Striker & Stenby, 103 East Neck Road, Huntington, NY, 11743, US

(21) Appl. No.: 10/472,433

(22) PCT Filed: Mar. 5, 2002
(86) PCT No.: PCT/EP02/02383

(30) Foreign Application Priority Data
Mar. 29, 2001 (DE) 101 15 591.3

(51) Int. Cl. C08K 3/00

(52) U.S. Cl. 524/589

(57) ABSTRACT

The invention relates to multi-component kits, comprising at least two components, which include mutually complementary precursors of curable reactive resins; to the use of appropriate combinations of complementary precursors at the desired site of use, especially in the form of those kits, for producing synthetic mortars; to obtainable synthetic mortars; and to methods comprising the use of those kits in fastening technology.

### SUMMARY OF THE INVENTION

The invention relates to multi-component kits, comprising at least two components, which include mutually complementary precursors of curable reactive resins; to the use of appropriate combinations of complementary precursors at the desired site of use, especially in the form of those kits, for producing synthetic mortars; to obtainable synthetic mortars; and to methods comprising the use of those kits in fastening technology.

### BACKGROUND TO THE INVENTION

Two-component-adhesive shell casings are known in fastening technology, especially for the fastening of anchors in drilled holes, which combine, for example, a resin (binder) and a hardener in an outer and an inner chamber, e.g. an outer ampoule containing the resin and an ampoule enclosed therein which contains the hardener. When the ampoules are broken by mechanical means, in the drilled hole, by driving in an anchor, the hardener and resin are mixed with one another and curing is started, resulting in cured synthetic mortars. An example is shown in DE 22 22 013. Also known are mortar compounds, for the fastening of anchoring means in solid receiving materials, which are characterised by a content of free radically-curable vinyl ester urethane resins, provided in their final form, as curable reactive resins (EP 0 432 087). The vinyl ester urethane resins serve to improve the strength properties of the resulting mortar compounds. Two-chamber shell casings are also mentioned therein. It would be desirable to make available new methods and kits making possible further improved adhesion properties, especially when the substrates used are damp or wet, and also improved low-temperature curing and improved post-curing. Because of the provision of the resins comprising curable reactive resins in their final form, they have a fixed, pre-determined structure and they cannot be varied in order to adapt to specific conditions, such as moisture in the drilled hole.

### GENERAL DESCRIPTION OF THE INVENTION

It has now been found, surprisingly, to be advantageous for the curable reactive resins not to be formed until mutually complementary starting compounds are reacted at the desired site of use, e.g. in front of or in holes, especially drilled holes, in which anchors are to be fastened, further components, especially those having a content of hardener, being mixed in at substantially the same time, in order, by that means, to produce synthetic mortars that have advantageous properties, for example high bonding stress values. The advantages over the systems known from the prior art, wherein the curable component is used in already finished form, as mentioned hereinabove, may possibly be explained and illustrated—although this explanation is not intended to exclude other possible explanations—by the fact that the use of the complementary starting components results in better wetting and consequently in an especially continuous interface between the resulting synthetic mortar and its surroundings, for example the material of the wall of a drilled hole. The combination and reaction of the components directly at the site of use accordingly results in an especially strong connection between the synthetic resin and the surrounding material. It is also possible, by varying the complementary starting components selected, to achieve optimum adaptation to the specific prevailing conditions. Further advantages include improved adhesion, especially in a damp drilled hole or on organic substrates, good post-curing even at low temperature, and/or very good resistance to alkalis.

Especially advantageous properties are obtained when, for producing synthetic mortars, mutually complementary starting components for curable urethanes, or especially for curable ureas (especially vinyl ester ureas) not known from the prior art, are used at the desired site of use, with admixture of one or more further components, such as hardener.

It is especially advantageous, in the case of all the afore-mentioned variants, that the components can be reacted with one another at the fastening site, especially in a hole, e.g. a drilled hole, and accordingly, by varying the complementary starting components used for the reactive resins, especially urethane and/or urea derivatives, a high degree of flexibility can be achieved, it being possible for components that are especially suitable for a specific purpose to be combined with one another in each case.

### DETAILED DESCRIPTION OF THE INVENTION

The invention relates to multi-component kits, comprising at least two separate components (a) and (b), which comprise mutually complementary precursors of curable reactive resins.

In especially preferred embodiments of the invention, the complementary precursors are preferably those required for producing reactive resins characterised by a content of curable urethane and/or urea derivatives, especially the latter; that is to say they are selected,

in the case of component (a),

for producing urethane derivatives, from one or more starting compounds carrying one (preferably) or more (in which case, especially two) hydroxy or mercapto groups; and/or, for producing urea derivatives, from one or more starting compounds carrying one (preferably) or more groups selected from primary and secondary amino groups; for producing mixed urea/urethane derivatives, from one or more starting compounds containing one or more hydroxy and/or mercapto groups and one or more primary and/or secondary amino groups; it being possible for one or more—in each case di- or higher functional—alcohols, amines or aminoalcohols or, furthermore, thioalcohols, thiols and/or aminothiols, to be additionally present; and,

in the case of component (b),

from one or more mono-, di- (preferably) or poly-isocyanates, or mixtures thereof; wherein at least the starting compounds mentioned under (a) (preferably), carrying groups selected from hydroxy, mercapto, primary amino and/or secondary amino groups, or the isocyanates mentioned under (b), especially the monoisocyanates, or, furthermore, both are curable; and wherein preferably a third component (c), spatially separated from the two components (a) and (b) and comprising a hardener, is additionally present (it also being possible for hardener to be alternatively or additionally present in component (a) and/or (b), if necessary in protected form); and wherein, if desired, further additives and/or reactants may be present in the mentioned components and/or, if present and desired, in further components.

The invention relates also to the use of combinations of mutually complementary starting products for curable reactive resins for producing synthetic mortars at the desired site of use, e.g. in front of or in holes, such as drilled holes, in which anchors are to be fastened, especially to the use of the mentioned multi-component kits for producing synthetic mortars; to synthetic mortars obtainable therewith; and also to methods which comprise the use of those combinations, especially kits, in fastening technology.

### DESCRIPTION OF THE FIGURES

FIG. 1 shows a three-chamber cartridge as an example of a multi-component kit. Chamber (1) contains component (a), chamber (2) contains component (b) and chamber (3) contains a hardener. (4) static mixer (shown partly broken-away).

### PREFERRED DEFINITIONS

The general expressions and symbols used in the context of the present disclosure preferably have the meanings given hereinbelow, it being possible hereinabove and hereinbelow for the more specific meanings to be used instead of the more general symbols and definitions, thereby describing preferred embodiments of the invention:

Percentages by weight (% by weight) referring to a particular component are based on the weight of the component in question unless otherwise specified. When referring to the finished synthetic mortar, those percentages refer to the mixture of all its components.

“Furthermore” means “in a broader, especially less preferred embodiment of the invention”. “In each case” means that the attribute mentioned after “in each case” (e.g. an adjective) applies to all the elements mentioned in a subsequent listing, up to and including those separated from the preceding one by “and”, “or” or “and/or”, that is to say the phrase does not relate only to the first element of the listing in question. “Comprising” (=“including”) means especially that further components, reactants, additives etc., besides those specifically mentioned in the particular case, may be present. “Containing” may, preferably, be used instead of “comprising” or “including”, which means that only those components, reactants, additives etc. that are mentioned in the particular case, and no others, may then be present.

“Separate” means especially that the components in question are present in spatially separated manner, that is to say are so combined with one another that they are not able to mix with each other of their own accord.

Halogen especially denotes fluorine, chlorine, bromine or iodine.

The prefix “lower” means that the radical in question has preferably up to 7, especially up to 4, carbon atoms.

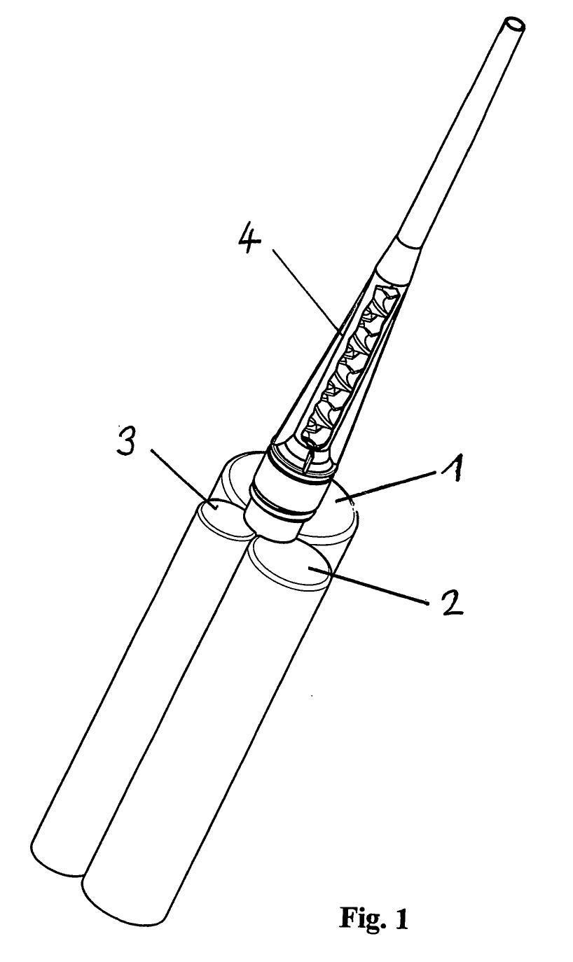

A multi-component kit comprising at least two (spatially) separate components (a) and (b), as defined hereinabove and hereinbelow, is to be understood as referring to a kit comprising two or more separate containers connected to one another and/or inserted one inside the other, one of which comprises component (a) and the other of which comprises component (b), a third component (c) comprising a hardener preferably also being present, and also, if desired, further containers containing further reactants or additives. It is to be understood especially as referring to an arrangement which allows components (a) and (b) and, subsequently or preferably simultaneously, (c), and also, if desired, further reactants and additives for producing a mortar obtainable as described hereinabove and hereinbelow, to be so mixed and, if necessary, introduced at the desired site of use, for example directly in front of or in a hole, especially a drilled hole, that the complementary starting—especially urea and/or urethane—compounds obtainable from components (a) and (b) can form the corresponding reactive resins and curing can take place there. The kit may consist of separate containers—although provided, for example, as a set, e.g. in a single package or a single container—for the resin, initiator or, where present, further additives, for example separate bottles, ampoules, tubes or cartridges for the components to be used, or preferably of cartridges of three or, furthermore, more chambers (having chambers arranged coaxially one inside the other or connected to one another (e.g. arranged in parallel next to one another), for holding the components in question) or shell casings, having three or, furthermore, more chambers, of glass (preferably), foils or plastics material, or combinations of two or more such containers, or, furthermore (especially in the case of cartridges), in combination with expressing devices, such as expelling guns, and/or static mixers or nozzles/delivery tubes for expressing, and/or, furthermore, containers for mixing, such as bowls or cups. An example of a preferred embodiment is shown in diagrammatic form in FIG. 1. Especially in the case of shell casings, the material of the walls thereof, e.g. glass, may be a constituent of the resulting synthetic mortar, as a further filler, after the application or filling procedure.

Curable reactive resins are especially those that are obtainable by reaction of complementary precursors consisting of two or more components, especially two components (a) and (b) (and optionally further additives or reactants), at least one of which comprises curable components. Preferred examples are epoxy resins, polyesters, polyethylene oxide esters or polyamides, which in each case comprise curable (e.g. olefinic) components.

The following starting compounds especially come into consideration:

For epoxy resins there come into consideration, primarily, as component (a) starting compounds carrying two or more hydroxy groups, preferably as defined hereinbelow for di- or higher functional alcohols, especially the non-curable analogues thereof, as defined hereinbelow, or analogues carrying double bonds, such as vinyl groups; as component (b) there come into consideration epichlorohydrin or analogues of epichlorohydrin, especially those containing curable groups, such as vinyl radicals, at least one of components (a) and (b) carrying curable groups.

For polyesters there come into consideration, primarily, as component (a), reactive derivatives, such as acid anhydrides or acid halides, of dicarboxylic acids and, as component (b), di- and higher functional alcohols, preferably as defined hereinbelow, at least one of those components carrying curable groups, such as vinyl groups.

For polyethylene oxide esters there come into consideration, primarily, as component (a), compounds of formula

Ω—(CH₂—CH₂O)ᵥ—H,

wherein Ω denotes alkyl (especially lower alkyl, aryl or aryl-lower alkyl, and v denotes a whole number equal to or greater than 2, especially between 2 and 100, and, as component (b), reactive derivatives, especially anhydrides or acid halides, of carboxylic acids containing curable groups, especially vinyl radicals, for example acrylic or methacrylic acid.

For polyamides there come into consideration, primarily, as component (a), reactive derivatives, especially acid anhydrides or acid halides, of dicarboxylic acids and, as component (b), di- or higher functional amines, preferably as defined hereinbelow, at least one of those components carrying curable groups, such as vinyl groups.

“Complementary precursors” means that, as a result of chemical reaction of the precursors complementing one another, molecules are obtainable, for example by addition or condensation, which include constituents of the molecules of the precursors, especially the starting compounds mentioned hereinabove and hereinbelow in the case of components (a) and (b).

The preferred curable starting compounds in component (a) which can be used for producing urethane derivatives and which carry one (preferably) or more hydroxy or mercapto groups, are especially those that contain, in addition to one or more hydroxy groups, one or more double bonds capable of polymerisation (i.e. curing), especially the esters or, furthermore, thio esters or amides of vinyl group-carrying or substituted vinyl group-carrying acids which carry the hydroxy group(s) on the radical of the alcohol, thiol or amino component contributing to the ester, thio ester or amide.

The especially preferred curable starting compounds in component (a) which can be used preferably for producing urea derivatives and which carry one (preferably) or more primary and/or (preferably) secondary amino groups, are especially those that contain, in addition to one or more primary or secondary amino groups, one or more double bonds capable of polymerisation (i.e. curing), especially the esters or, furthermore, thio esters or amides of vinyl group-carrying or substituted vinyl group-carrying acids which carry the primary and/or secondary amino group(s) on the radical of the alcohol, thiol or amino component contributing to the ester, thio ester or amide. Special preference is given to a component (a) which comprises curable starting compounds carrying one or more secondary amino groups.

The curable starting compounds which can be used preferably for producing mixed urea/urethane derivatives and which carry one or more hydroxy and/or mercapto groups and one or more primary and/or secondary amino groups, are especially those that contain, in addition to one or more hydroxy and/or mercapto groups and one or more primary and/or secondary amino groups, one or more double bonds capable of polymerisation (i.e. curing), especially the esters or, furthermore, thio esters or amides of vinyl group-carrying or substituted vinyl group-carrying acids which carry the hydroxy and/or mercapto groups and secondary amino group(s) on the radical of the alcohol, thiol or amino component contributing to the ester, thio ester or amide.

Preferred curable starting compounds are compounds of formula (A)

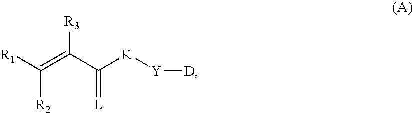

wherein

R₁, R₂ and R₃ denote, each independently of the others, hydrogen or lower alkyl, especially hydrogen or methyl; or

R₃ denotes cyano and R₁ and R₂ have the afore-mentioned meanings (leading to especially anionic polymerisation);

K and L denote, each independently of the other, oxygen or, furthermore, sulphur or denote NL* wherein L* is hydrogen or a radical selected from alkyl, especially lower alkyl, cycloalkyl, cycloalkylalkyl, aryl and aryl-lower alkyl, which are unsubstituted or substituted;

Y denotes unsubstituted or substituted alkylene, or unsubstituted or substituted cycloalkylene, arylene, heteroarylene or heteroalkylene, or a mixed aliphatic/aromatic, aliphatic/alicyclic or aliphatic/heterocyclic, unsubstituted or substituted, bivalent radical; or K and Y together or K alone denote(s) a bivalent heterocyclyl bonded by way of nitrogen; and

D denotes, for producing urethane derivatives, hydroxy or mercapto, and/or, for producing urea derivatives (which are preferred), primary or, especially, secondary amino;

or D and Y together, or D, Y and K together, denote an N-containing heterocyclyl radical bonded by way of nitrogen and containing, in addition to the bonding nitrogen, in the form of a free imino group (—NH—), nitrogen present in the ring as secondary amino (for urea derivatives).

Primary amino is —NH₂. A secondary amino group is a substituted amino group which in the uncharged state still carries one N-bonded hydrogen; as the N-substituent there come into consideration alkyl, cycloalkyl, cycloalkylalkyl, aryl, arylalkyl, heteroaryl or heteroarylalkyl, each of which may be substituted or preferably unsubstituted. A secondary amino group can also be an imino group which is a constituent of an N-containing heterocyclyl radical, as mentioned in the last paragraph. An especially preferred secondary amino group is a group of formula (B),

—N(—R)H (B),

wherein R denotes alkyl, especially lower alkyl, primarily α-branched lower alkyl, especially isopropyl, isobutyl, sec-butyl or tert-butyl, cycloalkyl, such as cyclopropyl, cyclobutyl, cyclopentyl or cyclohexyl, cycloalkyl-alkyl, especially cyclohexylmethyl, aryl, especially phenyl, or aryl-lower alkyl, especially phenyl-lower alkyl, such as benzyl, especially lower alkyl.

Mercapto-carrying compounds are especially compounds such as the above-mentioned primary amino- and/or secondary amino-carrying compounds wherein, instead of one or more of the free or secondary amino groups, a mercapto group is in each case present.

Where starting compounds are non-curable starting compounds carrying two or more hydroxy, mercapto, primary amino and/or secondary amino groups (especially of formula B as defined hereinabove), they are especially selected from organic compounds carrying two or more radicals independently selected from the mentioned groups. The compounds carrying two or more of those groups are especially aliphatic (increasing the flexibility), cycloaliphatic or aromatic (serving for chain rigidity) di- or poly-, more especially di-, tri- or tetra-, -(GR)-carrying compounds, especially di-(GR)-hexane, -1,4-butane, -1,5-2-methylpentane, -1,8-octane, -1,12-dodecane, 4,4′-dicyclohexylmethane, -isophorone, -2,4- or -2,6-(1-methylcyclohexane), or more especially aryl-di- or aryl-poly-(GR), especially di-(GR)-toluene, -diphenylmethane, 2,4,4′-tri-(GR)-diphenylmethane, xylenediol-1,3- or -1,4-di-(GR), wherein (GR) in each case denotes amino, secondary amino or mercapto, especially primary or preferably secondary amino.

Di- or higher functional alcohols, thiols, amines, thioalcohols, aminoalcohols or aminothiols are especially the in each case di- or higher functional alcohols or amino-alcohols or their thio analogues which are mentioned hereinbelow in the definition of prepolymers, or the di- or higher functional amines defined there. Hydroxy-carrying compounds are generally preferred over mercapto group-carrying starting compounds, as are di- or higher functional alcohols over corresponding thioalcohols, thiols, aminothiols or also corresponding aminoalcohols and over amino-amines. The attributive phrase “in each case di- or higher functional” herein relates to all the compounds mentioned thereafter up to and including that separated from the preceding one by “and”, “or” or “and/or”, that is to say the phrase does not relate only to the first element of the listing in question.

Those preferably bivalent, but also under certain circumstances—for increasing cross-linking -tri- or poly-valent, compounds serve the purpose, after components (a) and (b) and, optionally, further components, reactants and additives have been mixed, of reacting with the diisocyanates to form prepolymers wherein chain termination is then carried out by a curable starting compound containing a secondary amino group and/or, furthermore, a hydroxy or mercapto group, preferably of the kind defined as being preferred.

There may also be a content of already pre-formed reactive resins, especially curable urethane and/or urea derivatives both in component (a) and in component (b) or in further components (except the hardener component).

A component is to be understood as preferably referring to those compositions which have the composition described hereinabove or preferably hereinbelow for components (a), (b) or (c) and, furthermore, one or more further reactants and/or additives, in the case of components (a) and (b), or further components that exclude (i), if they comprise curable starting compounds, initiators, although the latter may be present if they are present in, for example, (micro-)encapsulated form; (ii), if they comprise hydroxy-, thio-, amino- or secondary amino-carrying compounds, isocyanates; and (iii), if they comprise isocyanates, that exclude hydroxy-, thio-, amino- or secondary amino-carrying compounds. Among the additives, preference is given to reactive diluents, fillers, accelerators and inhibitors, which are added especially in the amounts mentioned hereinbelow as being preferred.

Di- or poly-isocyanates are especially aliphatic (increasing the flexibility), cycloaliphatic or aromatic di- or poly-, especially di-, tri- or tetra-, isocyanates (serving for chain rigidity), especially hexane diisocyanate, dimethylene diisocyanate, 1,4-diisocyanato-butane, 1,5-diisocyanato-2-methylpentane, 1,8-diisocyanatooctane, 1,12-diisocyanato-dodecane, 4,4′-diisocyanatodicyclohexylmethane, isophorone diisocyanate, 1-methylcyclohexane 2,4- or 2,6-diisocyanate, 3-isocyanatomethyl-3,5,5-trimethylcyclohexyl isocyanate or, more especially, aryl di- or aryl poly-isocyanates, especially toluene diisocyanate, for example toluene 2,4- or 2,6-diisocyanate, diisocyanatodiphenylmethane, especially 4,4′-methylene-bis(phenyl isocyanate) (MDI), 4,4′-isopropylidene diphenyl isocyanate, 2,4,4′-triisocyanatodiphenylmethane, xylylene 1,3- or 1,4-diisocyanate; or crude polyisocyanates, which can be produced, for example, by aniline/formaldehyde condensation and subsequent phosgenation (cf. Ullmann, Verlag Chemie, 4th Edition, Volume 19, p. 303-305); or prepolymers having two or more isocyanato groups; or mixtures of two or more of the mentioned di- or poly-isocyanates. Special preference is given to diisocyanates or, furthermore, (for increased cross-linking as star-shaped molecules) triisocyanates.

The afore-mentioned prepolymers having two or more isocyanato groups are especially those that are formed by reaction starting from di- or poly-isocyanates, especially those mentioned in the last paragraph except for the prepolymers themselves, with in each case di- or higher functional alcohols (di- or poly-ols), amines or aminoalcohols, or mixtures of two or more thereof. Di- or higher functional alcohols are especially alcohols containing two or more alcohol functions, for example reaction products of ethylene oxide or propylene oxide, such as ethanediol, di- or tri-ethylene glycol, propane-1,2- or 1,3-diol, dipropylene glycol, other diols, such as 1,2-, 1,3- or 1,4-butanediol, 1,6-hexanediol, neopentyl glycol, 2-ethylpropane-1,3-diol or 2,2-bis(4-hydroxycyclohexyl)pro triethanolamine, bisphenol A or bisphenol F or oxyethylation, hydrogenation and/or halogenation products thereof, higher-hydric alcohols, such as, for example, glycerol, trimethylolpropane, hexanetriol and pentaerythritol, hydroxyl group-containing polyethers, for example oligomers of aliphatic or aromatic oxiranes and/or of higher cyclic ethers, for example ethylene oxide, propylene oxide, styrene oxide and furan, polyethers having in each case terminal hydroxy which contain aromatic structural units in the main chain, for example those of bisphenol A or F, hydroxyl group-containing polyesters based on the above-mentioned alcohols or polyethers and dicarboxylic acids or their anhydrides, for example adipic acid, phthalic acid, isophthalic acid, terephthalic acid, tetra- or hexahydrophthalic acid, endomethylene tetrahydrophthalic acid, tetrachlorophthalic acid or hexachloro-endomethylene tetrahydrophthalic acid, maleic acid, fumaric acid, itaconic acid, sebacic acid or the like. Special preference is given to hydroxyl compounds containing aromatic structural units bringing about chain rigidity, hydroxy compounds containing unsaturated components for increasing the cross-linking density, such as fumaric acid, or branched or star-shaped hydroxy compounds, especially tri- or higher functional alcohols and/or polyethers or polyesters which contain structural units thereof. Special preference is given to lower alkanediols (resulting in bivalent radicals —O-lower alkylene-O—). Aminoalcohols are compounds especially containing one or more hydroxy groups and one or more amino groups in one and the same molecule. Preferred examples are aliphatic aminols, especially hydroxy-lower alkylamines (resulting in radicals —NH-lower alkylene-O— or —O-lower alkylene-NH—), such as ethanolamine, diethanolamine or 3-aminopropanol, or aromatic aminols, such as 2-, 3- or 4-aminophenol. Di- or higher functional amines are organic amino compounds containing 2 or more amino groups, especially hydrazine, N,N′-dimethylhydrazine, aliphatic di- or poly-amines, especially lower alkanediamines (resulting in radicals —NH-lower alkyl-NH—), such as ethylenediamine, 1,3-diaminopropane, tetra- or hexamethylenediamine or diethylenetriamine, or aromatic di- or poly-amines, such as phenylenediamine, 2,4- and 2,6-toluenediamine, benzidine, o-chlorobenzidine, 2,5-pdichlorophenyldiamine, 3,3′-dichloro4,4′-diamino-diphenylmethane or 4,4′-diaminodiphenylmethane, polyether diamines (polyethylene oxides containing terminal amino groups), or polyphenyl/polymethylene-polyamines which are obtainable by condensation of anilines with formaldehyde. It is also possible for mixtures of two or more of the mentioned, in each case di- or higher functional alcohols or, furthermore, aminoalcohols or amines to be present. In a broader embodiment of the invention, instead of the in each case di- or higher functional alcohols or aminoalcohols, their thio analogues may also be present, in which one or more or all of the hydroxy or amino groups are present as mercapto groups. However, preference is given to the hydroxy compounds (less risk of oxidation and no odour of mercaptan). Special preference is given to diols or triols, furthermore aminoalcohols, diaminoalcohols, aminodiols, diamines or triamines, especially those specifically mentioned. The diols, amino-alcohols and diamines are especially preferred; to these there may furthermore be added (as star-shaped molecules) triols, diaminoalcohols, aminodiols or triamines.

The formation (production) of the prepolymers may be carried out at the same time as the reaction forming the curable urea derivatives according to the invention after mixing of at least components (a) and (b) and, if not already included in (a), the in each case di- or higher functional alcohols, aminoalcohols or amines or their thio analogues at the site of use or, furthermore, separately, before the said reaction. Preferably, prepolymers are not used, or, if they are used, then in cases of the exclusive use of curable urea derivatives as complementary precursors.

When produced beforehand, it is to be ensured, by virtue of the molar ratios, that two or more isocyanato groups can be present terminally, for example by using the in each case di- or higher functional alcohols, aminoalcohols and/or amines in a less-than-stoichiometric amount than the di- or poly-isocyanates. Even when the reaction is carried out simultaneously, the molar ratios of the reaction components are preferably so selected that not too many of the free-radically, anionically or cationically curable starting compounds, as defined for component (a), are present, because these would otherwise bring about early chain termination for the prepolymers. The total number of reactive hydrogens is preferably equal to or less than the total number of isocyanato groups.

A curable mono- or poly-isocyanate is especially a compound carrying one or more, especially one, isocyanato group(s) which is bonded to a radical containing one or more double bonds capable of polymerisation. Such compounds are especially the esters or, furthermore, thio esters or amides of vinyl group-carrying or substituted vinyl group-carrying acids, which carry the isocyanato group(s) on the radical of the alcohol, thiol or amine component contributing to the ester, thio ester or amide. The isocyanates of esters, thio esters or amides of vinyl group-carrying acids are especially those of formula (A*),

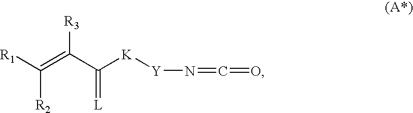

wherein

R₁, R₂ and R₃ denote, each independently of the others, hydrogen or lower alkyl especially hydrogen or methyl; or

R₃ denotes cyano and R₁ and R₂ have the afore-mentioned meanings (leading to especially anionic polymerisation);

K and L denote, each independently of the other, oxygen or, furthermore, sulphur or denote NL* wherein L* is hydrogen or a radical selected from alkyl, especially lower alkyl, cycloalkyl, cycloalkylalkyl, aryl and aryl-lower alkyl, which are unsubstituted or substituted; and

Y denotes unsubstituted or substituted alkylene, or unsubstituted or substituted cycloalkylene, arylene, heteroarylene or heteroalkylene, or a mixed aliphatic/aromatic, aliphatic/alicyclic or aliphatic/heterocyclic, unsubstituted or substituted, bivalent radical;

or K and Y together or K alone denote(s) a bivalent heterocyclyl bonded by way of nitrogen. Examples for preparation and preferred compounds of that kind are to be found in EP 0 315 876, which is incorporated herein by way of reference especially in this regard. A preferred example is isocyanatoethyl methacrylate.

Preference is given to the use thereof as component (b) when component (a) comprises non-curable starting compounds carrying two or more hydroxy, mercapto, primary amino and/or secondary amino groups.

Unsubstituted or substituted alkylene is preferably C₁-C₂₀alkylene, especially lower alkylene, which is unsubstituted or substituted by one or more, especially up to three, substituents selected each independently of the other(s) preferably from halogen, such as fluorine, chlorine, bromine or iodine, lower alkyl, such as methyl or ethyl, phenyl, phenyl-lower alkyl, lower alkoxy, phenyloxy, phenyl-lower alkoxy, lower alkoxycarbonyl, phenyloxycarbonyl, phenyl-lower alkoxycarbonyl, nitro and cyano. Preference is given to ethylene or 1,3-propylene.

Unsubstituted or substituted cycloalkylene is preferably C₃-C₁₂—, especially C₄-C₈—, cycloalkylene, especially cyclopentylene, cyclohexylene or cycloheptylene, which is unsubstituted or substituted by one or more, especially up to three, substituents mentioned as substituents for substituted alkylene.

Arylene is especially the bivalent radical of a mono- to penta-cyclic aromatic radical containing from 6 to 30, preferably from 6 to 25, carbon atoms, which is unsubstituted or substituted, preferably as described for substituted alkylene, and is especially phenylene, lower alkyl-substituted phenylene, such as methylphenylene, the bivalent (preferably 4,4′-) radical of diphenylmethane, diphenyl-lower alkyl-methane, diphenyl-di-lower alkyl-methane, diphenyl-(mono- or poly-halo-lower alkyl)-methane or diphenyl-bis(mono- or poly-halo-lower alkyl)methane, especially the bivalent (preferably 4,4′-) radical of diphenylmethane, 1,1-diphenylethane, 2,2-diphenylpropane or 2,2-diphenyl-1,1,1,3,3,3-hexafluoropropane; the bivalent radical, bonded by way of the two phenyl substituents, of 1,1-dimethyl-3-methyl-(4-phenyl)-5-indan or the bivalent radical, bonded by way of the two phenyl substituents, of 9,9-di-(4-phenyl)-fluorene.

Heteroarylene is preferably the bivalent radical of a mono- to penta-cyclic radical containing at least one heterocycle and containing one or more ring hetero atoms, especially from 1 to 3 ring hetero atoms selected from N, S and O, which is unsubstituted or substituted, preferably as described for substituted alkylene, and is, for example, piperidinylene, piperazinylene, pyridin-2,6-ylene, 2-methylpyridin-2,4-ylene, phenazin-2,3-ylene, or the bivalent radical, bonded by way of the phenyl substituents, of 2,5-di(4-phenyl)-1,3,4-oxadiazole or -thiadiazole.

Heteroalkylene is branched or, especially, linear alkylene containing up to 100, preferably up to 20, chain atoms, of which one or more may be hetero atoms, especially N, S or O; the others are carbon atoms. Examples are polyoxy-ethylene or -propylene radicals or polythio-ethylene or -propylene radicals.

In an unsubstituted or substituted mixed aliphatic/aromatic, aliphatic/alicyclic or aliphatic/heterocyclic bivalent radical, the aliphatic moiety is preferably an alkylene radical as defined hereinabove, especially methylene, whereas the aromatic moiety is preferably arylene, the alicyclic moiety is preferably as defined for cycloalkylene and the heterocyclic moiety is preferably as defined for heteroarylene.

Alkyl is especially C₁-C₂₄—, especially C₁-C₁₂—, more especially lower, alkyl, which is branched one or more times or unbranched (linear) and which is unsubstituted or substituted by one or more, especially up to three, of the substituents mentioned as substituents for substituted alkylene. Preference is given to methyl, ethyl, n- or iso- propyl, or n-, iso- or tert-butyl.

Cycloalkyl is preferably C₃-C₁₂—, especially C₄-C₈—, cycloalkyl, especially cyclopropyl, cyclobutyl, cyclopentyl, cyclohexyl or cycloheptyl, which is unsubstituted or substituted by one or more, especially up to three, of the substituents mentioned as substituents for substituted alkylene.

Cycloalkylalkyl is preferably C₄-C₁₆—, especially C₄-C₈—, cycloalkylalkyl, especially cyclopropylmethyl, cyclobutylmethyl, cyclopentylmethyl, cyclohexylmethyl or cycloheptylmethyl, and is unsubstituted or substituted by one or more, especially up to three, of the substituents mentioned as substituents for substituted alkylene.

Aryl is a mono- to penta-cyclic aromatic radical containing from 6 to 30, preferably from 6 to 25, especially from 6 to 14, carbon atoms, which is unsubstituted or substituted, preferably as described for substituted alkylene, more especially phenyl or naphthyl.

Arylalkyl has preferably from 7 to 37, especially from 7 to 16, carbon atoms, aryl and alkyl being as defined hereinabove, and is unsubstituted or substituted by one or more, especially up to three, of the substituents mentioned as substituents for substituted alkylene.

Heteroaryl is a mono- to penta-cyclic radical containing at least one heterocycle and containing one or more ring hetero atoms, especially from 1 to 3 ring hetero atoms selected from N, S and O, which is unsubstituted or substituted, preferably as described for substituted alkylene, and is, for example, pyrrolyl, thiazolyl, oxazolyl or pyridyl.

In heteroarylalkyl, heteroaryl is unsubstituted or substituted, preferably as defined in the afore-mentioned manner, and bonded by way of an unbranched or branched alkylene radical, as defined for alkylene, preferably terminally, especially at methylene.

An N-containing heterocyclyl radical is especially a mono- to penta-, preferably mono-, bi- or tri-, cyclic heterocyclyl radical containing from 4 to 20, preferably from 5 to 14, ring atoms, and containing one or more, preferably up to three, ring hetero atoms, preferably selected from N, O and S, which is present in unsubstituted form or substituted by one or more, preferably up to three, substituents, especially selected each independently of the other(s) from halogen, such as fluorine, chlorine, bromine or iodine, lower alkyl, such as methyl or ethyl, phenyl, phenyl-lower alkyl, lower alkoxy, phenyloxy, phenyl-lower alkoxy, lower alkoxycarbonyl, phenyloxycarbonyl, phenyl-lower alkoxycarbonyl, nitro and cyano, preferably an unsaturated heterocyclyl radical, for example piperidino, piperazino, morpholino, thiomorpholino or the like. Bivalent heterocyclyl (for example bonded by way of nitrogen) is preferably corresponding heterocyclylene. It is preferably heterocyclylene containing at least one or preferably two ring nitrogen atoms, especially the radicals specifically mentioned hereinabove which in each case fall within that definition.

The further reactants especially include reactive diluents (comonomers) with which, during curing, the new urea-derivative-based constituents can react instead of or in parallel to reacting with themselves. As reactive diluents there may be used any olefinically unsaturated compound suitable for the purpose, especially vinyl group-containing (including methacrylic or acrylic group-containing) compounds, for example styrene, divinylbenzene, mono-, di- and tri-acrylates or -methacrylates, such as methacrylic acid methyl ester, methacrylic acid isopropyl ester, methacrylic acid isobutyl ester, hexanediol diacrylate, tetraethylene glycol diacrylate, 2-hydroxypropyl methacrylate (2-HPMA), butanediol dimethacrylate (BDDMA), ethylene glycol dimethacrylate (EGDMA), trimethylolpropane trimethacrylate or tert-butyl aminoethyl methacrylate or vinyl acetate; or, furthermore, alkyl methacrylates (e.g. C₁₀-C₂₀alkyl, starting materials for “comb polymers”) or polyoxyethylene methacrylates, polyoxyethylene acrylates, polyoxyethylene 4-styryl-alkyl (especially methyl) esters, polyoxyethylene vinyl ethers or polyoxyethylene fumarates, p-n-alkyl-styrene, n-alkylvinyl ether, N-(n-alkyl)maleimide, N-vinylpyrrolidone, N-vinylcarbazole, α-methylstyrene, indene or furan; or the like, or mixtures thereof. These are preferably present in each component (especially (a) and (b)), except the hardener component (e.g. (c)) unless in suitably protected, for example micro-encapsulated, form, in a proportion by weight of up to 90% by weight, especially from 1 to 80 percent by weight (% by weight), more especially from 5 to 40% by weight, based on the component in question.

The components, especially (a) or (b), or both, may be pre-accelerated using, for example, pre-accelerators customary for cold-curing unsaturated polyesters (UP), especially using tertiary aromatic amines or heavy metal salts. Of the tertiary aromatic amines the following, especially, are possible: N,N-di-lower alkyl- or N,N-di-(hydroxy-lower alkyl)-anilines, -toluidines or -xylidines, especially N,N-dimethyl- or N,N-diethyl-aniline, N,N-dimethyl- or N,N-diethyl-toluidines or -xylidines, such as N,N-dimethyl-p-toluidine, N,N-diisopropylindene-p-toluidine or N,N-bis(hydroxyethyl)-xylidine; as heavy metals salts, the following are, for example, possible: carboxylic acid salts of transition metals, such as cobalt octanoate or cobalt naphthenate, or organic vanadium salts.

For the purpose of inhibition, inhibitors, especially quinones, sterically hindered quinones, hydroquinones, such as methyl-, dimethyl- or trimethyl-quinones, or phenols, such as 4,4′-bis(2,6-di-tert-butylphenol), 1,3,5-trimethyl-2,4,6-tris(3,5-di-tert-butyl4-hydroxybenzyl)benz or p-methoxyphenol, or phenothiazines or the like may be added to the pre-accelerated components, especially to those starting compounds containing curable groups. The accelerators are preferably present in the component in question in an amount of up to 8% by weight, especially between 0.01 and 5% by weight, more especially between 0.05 and 2% by weight. The inhibitors are preferably present in the component in question in an amount of up to 2% by weight, especially between 0.001 and 0.1% by weight.

As further additives, there are used, especially, fillers, especially mineral or mineral-like fillers, such as quartz, glass, porcelain, corundum, ceramics, talc, silicic acid (e.g. pyrogenic silicic acid), silicates, clay, titanium dioxide, chalk, barite, feldspar, basalt, aluminium hydroxide, granite or sandstone, polymeric fillers, such as thermosetting plastics, hydraulically curable fillers, such as gypsum, burnt lime or cement (e.g. Portland or aluminous cement), metals, such as aluminium, soot, or, furthermore, wood, mineral or organic fibres, or the like, or mixtures of two or more thereof. The fillers may be present in any form. Fillers are preferably present in the component in question in an amount of up to 90% by weight, especially from 3 to 85% by weight, more especially from 5 to 70% by weight.

Further possible additives are, furthermore, thixotropic agents, e.g. pyrogenic silicic acid, dyes or pigments, plasticisers, such as phthalic acid esters or sebacic acid esters, stabilisers, antistatic agents, thickeners or the like, which are preferably present in an amount of up to 15% by weight in total, preferably between 0.01 and 5% by weight, based on the finished synthetic mortar. Solvents may also be present, preferably in an amount of up to 30% by weight, based on the finished synthetic mortar, for example from 1 to 20% by weight, for example lower alkyl ketones, e.g. acetone, di-lower alkyl-lower alkanoyl amides, such as dimethylacetamide, lower alkyl benzenes, such as xylenes or toluene, phthalic acid esters or paraffins, or water.

“Curable” means polymerisable as a result of anionic, cationic or, primarily, free radical polymerisation, preferably triggered by initiators, but also without the specific addition of initiators, for example by hydroxy ions from atmospheric moisture.

As initiators for curing of the resins there are used, in the case of free radical polymerisation, free-radical-forming compounds, primarily organic peroxides, such as diacyl peroxides, e.g. diacetyl peroxide, benzoyl or bis(4-chlorobenzoyl) peroxide, ketone peroxides, such as methyl ethyl ketone peroxide or cyclohexanone peroxide, or alkyl peresters, such as tert-butyl perbenzoate, or, furthermore, there come into consideration azo initiators, such as azonitriles, e.g. azobisisobutyronitrile or 2,2′-azobis(2,4-dimethylvaleronitrile), azo esters, such as dimethyl-2,2′-azobisisobutyrate, azo amides, such as 2,2′-azobis[2-methyl-N-(2-hydroxyethyl)propionamide], azo alkanes, such as 2,2′-azobis(2-methylpropane), azo amidines, such as 2,2′-azobis(2-methylpropionamidine) dihydrochloride, or azo imidazolines, such as 2,2′-azobis[2-(2-imidazolin-2-yl)propane] dihydrochloride, or persulphates or perborates, and also mixtures thereof. The initiators may be in pure form, for example tert-butyl perbenzoate, or, preferably, desensitised, e.g. using gypsum, chalk, pyrogenic silicic acid, phthalates, such as, especially, dicyclohexyl phthalate, chloroparaffin or the like, and, if desired, a filler may be added thereto, especially a filler as mentioned hereinabove, and/or (especially for producing a paste or emulsion) a solvent, especially water; the initiator is present in an amount of especially from 1 to 80% by weight, preferably from 30 to 70% by weight, and the desensitising agent in an amount of from 1 to 80% by weight, preferably from 20 to 70% by weight, in each case based on the total amount of hardener; fillers are present in an amount of from 0 to 50%, preferably from 0 to 20%, for example from 5 to 20%; and/or solvents are present in an amount of from 0 to 60%, preferably from 20 to 50%; and the hardeners are used as a powder (preferably), paste or emulsion.

As initiators for anionic polymerisation (which can be used in the case of, for example, α-cyanoacrylates) there are used, for example, metal alkyls, alcoholates, metal amides or metal hydroxides, e.g. sodium amide. As initiators for cationic polymerisation, for example in the case of vinyl ethers, Lewis acids are suitable, such as boron fluoride, aluminium chloride, titanium(lV) chloride or tin(lV) chloride. Free radical polymerisation is preferred.

The term “hardener” (especially as component (c)) hereinabove and hereinbelow includes pure initiators and desensitised hardeners with or without added filler and/or added solvent, in other words the complete hardener component.

The hardener may be incorporated in the non-curable component (especially the isocyanate component) and/or (especially in protected form, that is to say in, for example, micro-encapsulated form) in the curable component.

The amount of the hardener is in the range from 0.1 to 30% by weight, preferably from 0.5 to 25% by weight, based on the weight of all the components taken together.

A preferred multi-component kit according to the invention comprises three components, namely component (a), as described hereinabove, especially comprising a plurality of or, especially, one curable starting compound(s) carrying a plurality of or, preferably, one secondary amino group and, optionally, further additives, especially reactive diluents, fillers and/or in each case di- or higher functional alcohols, amines or aminoalcohols; component (b) comprising non-curable di- or, furthermore, polyisocyanates, especially one diisocyanate, and, optionally, further additives, such as reactive diluents, fillers, accelerators and inhibitors; and component (c) as hardener, especially comprising one or more initiators and desensitising agents and, if desired, fillers. Preferably, the weight of the matter of component (a) involved in the formation of the synthetic resin is from 5 to 90% by weight, preferably from 20 to 80%, that of component (b) from 5 to 90% by weight, preferably from 20 to 80% by weight, and that of component (c) (hardener) from 0.1 to 30% by weight, preferably from 0.5 to 25% by weight, based on the total weight of the mixed components (finished synthetic mortar). If further components are present, these may in each case be present preferably in an amount up to 30% by weight, for example from 5 to 25% by weight, based on the total weight of the mixed components or to-be-mixed components.

The invention relates also to the use of the multi-component kits in producing synthetic mortars, and to methods comprising the use of those kits or of combinations of corresponding complementary precursors at the desired site of use in fastening technology.

The use of a multi-component kit according to the invention or the use of a combination of corresponding complementary precursors at the desired site of use is performed by mixing the associated components, especially components (a), (b) and (c), preferably those mentioned hereinabove and hereinbelow as being preferred, at the desired site of use, especially directly in front of a hole or within a hole, for example a drilled hole. Mixing can be carried out outside the hole, for example in a vessel, e.g. a bowl, or preferably in a static mixer on a multi-chamber, especially three-chamber, cartridge or within the hole, for example when multi-chamber shell casings, especially three-chamber shell casings, are used. A synthetic mortar having the advantageous properties described herein is obtained.

A synthetic mortar is understood to be especially a synthetic mortar obtainable, at the desired site of use, preferably in a drilled hole, starting from the components according to the invention, especially (a), (b) and (c), especially those mentioned as being preferred, especially as a result of the use, described in the last paragraph, of a multi-component kit according to the invention.

A fastening is to be understood as being especially a fastening employing anchoring means made of metal (e.g. undercut anchors, threaded rods or bore anchors) or of another material, such as plastics or wood, in solid receiving materials, especially in so far as they are constituents of artificially erected structures, more especially masonry, panels, posts or the like (e.g. made of concrete, natural stone, masonry of solid blocks or hollow blocks or, furthermore, plastics or wood), especially in holes, such as drilled holes.

Introduction and mixture (use) are performed, in the case of shell casings, preferably together with the anchoring means, especially one of those described in the last paragraph; and when separate containers or, especially, expelling guns are used, by means of cartridges, wherein the components are mixed in a static mixer, especially directly before introduction of the anchoring means. By way of explanation: As of the mixing and introduction of the components, especially (a) and (b) and, where appropriate, (c), at or into the desired sites, where anchoring means are to be fastened, especially holes, such as drilled holes, there begin a number of reactions which proceed substantially in parallel and/or only with a slight disparity in time, especially the formation of the reactive resin but also, for example, reactions of the said mixture or of individual constituents thereof with the material of the anchoring substrate, for example with the material of the walls of the holes, penetration of the substrate material by the said mixture or individual constituents, prepolymer formation and further reactions. The final full curing is carried out in situ.

New fastening methods comprising the use of the multi-component kits according to the invention are characterised especially by the method steps mentioned in the two preceding paragraphs. The fastening means, e.g. anchors, may be introduced, for example, by driving in, rotating, pushing in or combinations thereof.

### Preferred Embodiments of the Invention

In the case of the preferred embodiments of the invention hereinbelow there may be used, instead of general terms, the more specific definitions given hereinabove or hereinbelow, thereby defining especially preferred embodiments of the invention.

(I) Preference is given hereinabove and hereinbelow to multi-component kits, to the use thereof, to the use of corresponding combinations of complementary precursors at the desired site of use and/or to synthetic mortars obtainable therewith in each case, wherein component (a) comprises either starting compounds for urethane derivatives carrying one or, furthermore, more hydroxy groups or starting compounds carrying one or, furthermore, more primary or (preferably) secondary amino groups, whereas component (b) comprises one or, furthermore, more di- or poly-isocyanates, or mixtures thereof, whereas the other components, additives and reactants are in each case as described.

(II) The invention relates preferably to a multi-component kit comprising at least two separate components (a) and (b) which comprise mutually complementary precursors of resins characterised by a content of curable urethane and/or urea derivatives, wherein the complementary precursors are selected,

in the case of component (a),

for producing urethane derivatives, from one or more curable starting compounds carrying one (preferably) or more hydroxy groups; and/or, for producing urea derivatives, from one or more curable starting compounds carrying one (preferably) or more primary or (preferably) secondary amino groups; for producing mixed urea/urethane derivatives, from one or more curable starting compounds containing one or more hydroxy groups and one or more primary or (preferably) secondary amino groups; it being possible, furthermore, for one or more in each case di- or higher functional alcohols, aminoalcohols and/or amines to be additionally present; wherein the curable starting compounds are preferably compounds of formula (A) indicated above wherein

R₁, R₂ and R₃ denote, each independently of the others, hydrogen or lower alkyl, especially hydrogen or methyl; or

R₃ denotes cyano and R₁ and R₂ have the afore-mentioned meanings (leading to especially anionic polymerisation);

K and L denote, each independently of the other, oxygen or, furthermore, sulphur or denote NL* wherein L* is hydrogen or a radical selected from alkyl, especially lower alkyl, cycloalkyl, cycloalkylalkyl, aryl and aryl-lower alkyl, which are unsubstituted or substituted;

Y denotes unsubstituted or substituted alkylene, or unsubstituted or substituted cycloalkylene, arylene, heteroarylene or heteroalkylene, or a mixed aliphatic/aromatic, aliphatic/alicyclic or aliphatic/heterocyclic, unsubstituted or substituted, bivalent radical;

or K and Y together or K alone denote(s) a bivalent heterocyclyl bonded by way of nitrogen; and

D denotes, for producing urethane derivatives, hydroxy and/or, for producing urea derivatives (which are preferred), primary or (preferably) secondary amino, or, furthermore, denotes —NH₂;

or D and Y together, or D, Y and K together, denote an N-containing heterocyclyl radical bonded by way of nitrogen and containing, in addition to the bonding nitrogen, in the form of a free imino group (—NH—), nitrogen present in the ring as secondary amino (for urea derivatives); wherein secondary amino is preferably a group of formula B indicated above, wherein

R denotes alkyl, especially lower alkyl, primarily cx-branched lower alkyl, especially isopropyl, isobutyl, sec-butyl or tert-butyl, cycloalkyl, such as cyclopropyl, cyclobutyl, cyclopentyl or cyclohexyl, cycloalkyl-alkyl, especially cyclohexylmethyl, aryl, especially phenyl, or aryl-lower alkyl, especially phenyl-lower alkyl, such as benzyl, especially lower alkyl; and,

in the case of component (b),

from one or more di- (preferably) or poly-isocyanates, or mixtures thereof; and wherein preferably a third component (c), likewise spatially separated from the two components (a) and (b) and comprising a hardener, is additionally present; and wherein further additives and/or reactants may be present in the components, especially fillers and/or reactive diluents in component (a), fillers, reactive diluents, accelerators and/or inhibitors in component (b), and fillers in component (c);

to the use thereof, to the use of corresponding combinations of complementary precursors at the desired site of use and/or to synthetic mortars obtainable therewith in each case.

(III) Greater preference is given to a multi-component kit comprising at least two separate components (a) and (b) which comprise mutually complementary precursors of resins characterised by a content of curable urethane and/or urea derivatives, wherein the complementary precursors are selected,

in the case of component (a),

from one or more compounds of formula (A) indicated above, wherein

R₁, R₂ and R₃ denote, each independently of the others, hydrogen or lower alkyl,

especially hydrogen or methyl;

K and L denote oxygen;

Y denotes lower alkylene; and D denotes —OH (for urethane derivatives) or denotes —N(R)H wherein R denotes lower alkyl, primarily α-branched lower alkyl, especially isopropyl, isobutyl, sec-butyl or tert-butyl; and,

in the case of component (b),

from one or more di- and poly-isocyanates, especially aliphatic, cycloaliphatic or

aromatic di- or poly-, more especially di-, tri- or tetra-, isocyanates;

and wherein preferably a third component (c), likewise spatially separated from the two components (a) and (b) and comprising a hardener, is additionally present; and wherein further additives and/or reactants may be present in the components, especially, in component (a), fillers (preferably up to 90% by weight, especially from 3 to 85% by weight, more especially from 5 to 70% by weight, based on component (a)) and/or reactive diluents (preferably up to 90% by weight, especially from 1 to 80% by weight, more especially from 5 to 40% by weight, based on component (a)); in component (b), fillers (preferably up to 90% by weight, especially from 3 to 85% by weight, more especially from 5 to 70% by weight, based on component (b)), reactive diluents (preferably up to 90% by weight, especially from 1 to 80% by weight, more especially from 5 to 40% by weight, based on component (b)), accelerators (preferably up to 5% by weight, especially between 0.01 and 3% by weight, more especially between 0.05 and 2% by weight, based on component (b)) and/or inhibitors (preferably up to 2% by weight, especially between 0.01 and 1% by weight, based on component (b)), and, in component (c), fillers (preferably up to 90% by weight, especially from 3 to 85% by weight, more especially from 5 to 65% by weight, based on component (c)); to the use thereof, to the use of corresponding combinations of complementary precursors at the desired site of use and/or to synthetic mortars obtainable therewith in each case.

(IV) Preferably, in the last three preceding paragraphs, the weight of the matter of component (a) is from 5 to 90% by weight, preferably from 20 to 80%, that of component (b) from 5 to 90% by weight, especially from 20 to 80% by weight, and that of component (c) (hardener) from 0.1 to 30% by weight, especially from 0.5 to 25% by weight, based on the total weight of the components to be mixed.

(V) As synthetic mortar, special preference is given to a synthetic mortar which is obtainable after mixing the components according to one of the last four or next two paragraphs at the desired site of use, especially in a drilled hole, wherein it is possible, where appropriate, for remnants of a used multi-chamber shell casing still to be present in the form of further fillers.

(VI) A preferred multi-component kit includes three components (a), (b) and (c) as described hereinabove and hereinbelow, in a multi-chamber cartridge or multi-chamber shell casing, especially each in one of the three chambers of a three-chamber cartridge or a three-chamber shell casing.

(VII) The use of a multi-component kit according to the invention or a combination of corresponding complementary precursors is carried out preferably by mixing the associated components mentioned in the preceding paragraphs (I) to (IV), especially components (a), (b) and (c), at the desired site of use, especially directly in front of a hole or within a hole, for example a drilled hole. Mixing can be carried out outside the hole, for example in a vessel, e.g. a bowl, or, preferably, in a static mixer on a multi-chamber cartridge, especially a three-chamber cartridge, or within the hole, for example when shell casings, especially three-chamber shell casings, are used. A synthetic mortar having the advantageous properties described hereinabove and hereinbelow is obtained.

Preference is given also to a method of fastening anchors in holes which comprises the use of a multi-component kit according to one of paragraphs (I) to (IV) and (VI). Introduction and mixture are performed, in the case of shell casings, preferably together with the anchoring means and, when separate containers or, especially, expelling guns are used, by means of cartridges, wherein the components are mixed in a static mixer, especially directly before introduction of the anchoring means.

The invention relates especially to the components and multi-component kits mentioned in the Examples, to the uses indicated therein and to the synthetic mortars obtainable in accordance with the Examples.

The starting materials for the resins and synthetic mortars according to the invention, or precursors thereof, are known, commercially available and/or can be prepared by methods known per se.

### EXAMPLES

The Examples that follow serve to illustrate the invention, without implying any limitation.

### Example 1

### M12 Shell Casing (e.g. for Fastening an M12 Threaded Rod)

a) Component (a*) comprising, as curable secondary amine, tert-butylaminoethyl methacrylate, component (b*) comprising, as diisocyanate, diphenylmethane diisocyanate, and component (c*) comprising, as initiator, dibenzoyl peroxide are introduced separately into the chambers (component (b*) outer glass container (largest ampoule); larger inner glass container (component (a*)) and inner glass container (smallest ampoule, component (c*))) of an M12 shell casing.

| | |
|---|---|
| Outer glass container: Component (b*) | |
| Diphenylmethane diisocyanate 60% in BDDMA, pre-accelerated | 3.4 g |
| and inhibited by means of benzoquinone | |
| Dry glass beads (particle size 150-200 μm) | 3.5 g |
| Larger inner glass container: Component (a*) | |
| tert-Butylaminoethyl methacrylate | 1.7 g |
| BDDMA | 0.5 g |
| Quartz sand (particle size 1.2-1.8 mm) | 4.0 g |
| Smaller inner glass container: Component (c*) | |
| Dibenzoyl peroxide 50% in dicyclohexyl phthalate | 0.3 g |

b) As an example of use, the shell casing described under a) is used as follows: The drilled hole is thoroughly cleaned, the shell casing is inserted therein and the threaded rod is installed by being rotated and driven in.

### Example 2

### Injection Mortar for 3-chamber Cartridge

a) A three-chamber cartridge, as shown in FIG. 1, is filled with the following components:

| Component (a) (chamber (1)): | | |
|---|---|---|
| tert-Butylaminoethyl methacrylate | 55 | g |
| Quartz sand | 36 | g |
| Silicic acid | 6 | g |
| Diethylaniline | 2 | g |
| Additives | 0.5 | g |
| Hydroquinone | 0.5 | g |
| Component (b) (chamber (2)): | | |
| Diphenylmethane diisocyanate | 97 | g |
| Silicic acid | 3 | g |
| Component (c) (chamber (3)): | | |
| Dibenzoyl peroxide | 20 | g |
| Desensitising agent | 35 | g |
| Gypsum | 40 | g |
| Additives and dyes | 3 | g |
| Silicic acid | 2 | g |

The volumetric ratio of components (b):(a):(c) is 1:2.5:0.2.

### Example 3

### 3-Component Shell Casing (M12)

Analogously to Example 1, the two inner glass containers 1 and 2 in each case filled with the components mentioned below are enclosed within the outer glass container also filled as described below:

| Outer glass container (Component (b)) | | |
|---|---|---|
| Diphenylmethane diisocyanate | 2.5 | g |
| Inner glass container 1 (Component (a)) | | |
| 2-Hydroxypropyl methacrylate | 1.43 | g |
| DABCO (Air Products) | 0.03 | g |
| Hydroquinone | 0.02 | g |
| 1,4-Butanediol methacrylate | 1.43 | g |
| Dimethylaniline | 0.08 | g |
| Corundum (particle size 1-2 mm) | 8.1 | g |
| Inner glass container 2 (Component (c)) | | |
| Dibenzoyl peroxide | 0.3 | g |

1. Multi-component kits comprising at least two separate components (a) and (b), which comprise mutually complementary precursors of a curable reactive resin.

2. Multi-component kit according to claim 1, wherein the mutually complementary precursors are selected from those required for producing curable (in each case) urethanes, urea derivatives, epoxy resins, polyesters, polyethylene oxide esters or polyamides.

3. Multi-component kit according to claim 1, comprising at least two separate components (a) and (b), which comprise mutually complementary precursors of resins characterised by a content of curable urethane and/or urea derivatives, wherein the complementary precursors are selected,
in the case of component (a),
for producing urethane derivatives, from one or more starting compounds carrying one or more hydroxy or mercapto groups; and/or, for producing urea derivatives, from one or more starting compounds carrying one or more groups selected from primary and secondary amino groups; for producing mixed urea/urethane derivatives, from one or more starting compounds containing one or more hydroxy and/or mercapto groups and one or more primary and/or secondary amino groups; it being possible for one or more—in each case di- or higher functional—alcohols, amines, aminoalcohols, thioalcohols, thiols and/or aminothiols, to be additionally present; and,
in the case of component (b),
from one or more mono-, di- or poly-isocyanates, or mixtures thereof; wherein at least the starting compounds mentioned under (a), carrying hydroxy or mercapto groups and primary and/or secondary amino groups, or the isocyanates mentioned under (b), or both, are curable.

4. Multi-component kit according to claim 3, wherein a third component (c), likewise spatially separated from the two components (a) and (b) and comprising a hardener, is additionally present; and, if desired, further additives and/or reactants are present in the mentioned components and/or, if present and desired, in further components.

5. Multi-component kit according to claim 3 or 4, wherein the complementary precursors are selected,
in the case of component (a),
for producing urethane derivatives, from one or more curable starting compounds carrying one (preferably) or more hydroxy groups; and/or, for producing urea derivatives, from one or more curable starting compounds carrying one (preferably) or more primary or (preferably) secondary amino groups; for producing mixed urea/urethane derivatives, from one or more curable starting compounds containing one or more hydroxy groups and one or more primary or (preferably) secondary amino groups; it being possible, furthermore, for one or more in each case di- or higher functional alcohols, aminoalcohols and/or amines to be additionally present;
wherein the curable starting compounds are preferably compounds of formula (A) 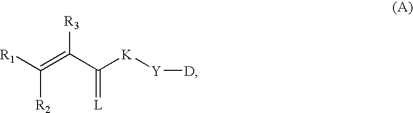
wherein
R₁, R₂ and R₃ denote, each independently of the others, hydrogen or lower alkyl, especially hydrogen or methyl; or
R₃ denotes cyano and R₁ and R₂ have the afore-mentioned meanings (leading to especially anionic polymerisation);
K and L denote, each independently of the other, oxygen or, furthermore, sulphur or denote NL* wherein L* is hydrogen or a radical selected from alkyl, especially lower alkyl, cycloalkyl, cycloalkylalkyl, aryl and aryl-lower alkyl, which are unsubstituted or substituted;
Y denotes unsubstituted or substituted alkylene, or unsubstituted or substituted cycloalkylene, arylene, heteroarylene or heteroalkylene, or a mixed aliphatic/aromatic, aliphatic/alicyclic or aliphatic/heterocyclic, unsubstituted or substituted, bivalent radical;
or K and Y together or K alone denote(s) a bivalent heterocyclyl bonded by way of nitrogen; and
D denotes, for producing urethane derivatives, hydroxy and/or, for producing urea derivatives (which are preferred), primary or (especially) secondary amino; or D and Y together, or D, Y and K together, denote an N-containing heterocyclyl radical bonded by way of nitrogen and containing, in addition to the bonding nitrogen, in the form of a free imino group (—NH—), nitrogen present in the ring as secondary amino (for urea derivatives); wherein secondary amino is preferably a group of formula B
—N(—R)H (B),
wherein
R denotes alkyl, especially lower alkyl, primarily α-branched lower alkyl, especially isopropyl, isobutyl, sec-butyl or tert-butyl, cycloalkyl, such as cyclopropyl, cyclo-butyl, cyclopentyl or cyclohexyl, cycloalkyl-alkyl, especially cyclohexylmethyl, aryl, especially phenyl, or aryl-lower alkyl, especially phenyl-lower alkyl, such as benzyl, especially lower alkyl; and,
in the case of component (b),
from one or more di- (preferably) or poly-isocyanates, or mixtures thereof;
and wherein preferably a third component (c), likewise spatially separated from the two components (a) and (b) and comprising a hardener, is additionally present;
and wherein further additives and/or reactants may be present in the components, especially fillers and/or reactive diluents in component (a), fillers, reactive diluents, accelerators and/or inhibitors in component (b), and fillers in component (c).

6. Multi-component kit according to one of claims 3 to 5, comprising at least two separate components (a) and (b) which comprise mutually complementary precursors of resins characterised by a content of curable urethane and/or urea derivatives, wherein the complementary precursors are selected, in the case of component (a), from one or more compounds of formula (A) indicated in claim 3, wherein
R₁, R₂ and R₃ denote, each independently of the others, hydrogen or lower alkyl, especially hydrogen or methyl;
K and L denote oxygen;
Y denotes lower alkylene; and D denotes —OH (for urethane derivatives) or denotes —N(R)H wherein R denotes lower alkyl, primarily α-branched lower alkyl, especially isopropyl, isobutyl, sec-butyl or tert-butyl, or, furthermore, —NH₂; and,
in the case of component (b), from one or more di- and poly-isocyanates, especially aliphatic, cycloaliphatic or aromatic di- or poly-, more especially di-, tri- or tetra-, isocyanates;
and wherein preferably a third component (c), likewise spatially separated from the two components (a) and (b) and comprising a hardener, is additionally present;
and wherein further additives and/or reactants may be present in the components, especially, in component (a), fillers (preferably up to 90% by weight, based on component (a)) and/or reactive diluents (preferably up to 90% by weight, based on component (a)); in component (b), fillers (preferably up to 90% by weight, based on component (b)), reactive diluents (preferably up to 90% by weight, based on component (b)), accelerators (preferably up to 5% by weight, based on component (b)) and/or inhibitors (preferably up to 2% by weight, based on component (b)), and, in component (c), fillers (preferably up to 90% by weight, based on component (c)).

7. Multi-component kit comprising three components, according to one of claims 3 to 6, wherein the weight of the matter of component (a) is from 5 to 90% by weight, preferably from 20 to 80%, that of component (b) from 5 to 90% by weight, especially from 20 to 80% by weight, and that of component (c) (hardener) from 0.1 to 30% by weight, especially from 0.5 to 25% by weight, based on the total weight of the components to be mixed.

8. Multi-component kit according to one of claims 3 to 7, wherein component (a) comprises starting compounds for urethane derivatives carrying one or, furthermore, more hydroxy groups whereas component (b) comprises one or, furthermore, more di- or poly-isocyanates, or mixtures thereof.

9. Synthetic mortar obtainable after mixing the components according to one of claims 1 to 8 at the desired site of use.

10. Use of a multi-component kit according to one of claims 1 to 8, comprising mixing the associated components, especially components (a), (b) and (c) at the desired site of use, especially directly in front of a hole or within a hole, for example a drilled hole.

11. Method of fastening anchors in holes, which comprises the use of a multi-component kit according to one of claims 1 to 8.

12. Use of a combination of precursors of the multi-component kit components mentioned in one of claims 1 to 8 for producing a synthetic resin at the desired site of use.
